(19) United States
(12) Patent Application Publication
(10) Pub. No.: US 2026/0081092 A1
(43) Pub. Date: Mar. 19, 2026

(54) X-RAY FLUOROSCOPIC IMAGING APPARATUS

(71) Applicant: SHIMADZU CORPORATION, Kyoto-shi (JP)

(72) Inventor: Yoshihiro ATSUMI, Kyoto-shi (JP)

(21) Appl. No.: 19/325,837

(22) Filed: Sep. 11, 2025

(30) Foreign Application Priority Data
Sep. 18, 2024 (JP) 2024-161200

(51) Int. Cl. H01J 35/16; G01T 7/00; H01J 35/14

(52) U.S. Cl. CPC H01J 35/16; G01T 7/00; H01J 35/153; H01J 2235/166

(57) ABSTRACT

An X-ray imaging apparatus includes: a tabletop having a placement surface on which a subject is placed; an irradiation unit that irradiates X-rays; a detection unit that detects X-rays that have been irradiated from the irradiation unit and have passed through the subject; an X-ray shielding part, one end of which is attached to the irradiation unit or the detection unit and the other end of which extends toward the placement surface; and a moving mechanism that moves the irradiation unit and the detection unit, wherein a space is formed in a part of the X-ray shielding part on the one end side, and a shielding transparent member that shields X-rays but transmits visible light is attached in the space.

### TECHNICAL FIELD

The present disclosure relates to an X-ray fluoroscopic imaging apparatus.

### BACKGROUND ART

Conventionally, X-ray imaging apparatuses are used in contrast examinations of the digestive tract using barium. Some X-ray imaging apparatuses are configured such that an operator is positioned near the X-ray imaging apparatus to give instructions to a subject placed on a tabletop and to operate the X-ray imaging system. In such X-ray imaging apparatuses, a configuration including an X-ray shielding mechanism has been proposed to reduce the exposure of the operator, who is located near the X-ray apparatus, to scattered X-rays from the subject (see, for example, Patent Literature 1). This X-ray shielding mechanism includes a sheet-like shielding material made of lead or the like. The sheet-like shielding material shields the space between the operator, who is positioned near the tabletop, and the X-ray imaging apparatus, thereby reducing the operator's exposure dose.

### PRIOR ART DOCUMENTS

### Patent Literature

[Patent Literature 1] Japanese Unexamined Patent Application Publication No. 2008-061765

### SUMMARY OF INVENTION

### Technical Problem

However, in the conventional technology described above, because the sheet-like shielding material shields the space between the operator and the subject, the subject is hidden by the sheet-like shielding material, and the operator cannot visually confirm the positional relationship of the subject, such as the irradiation position of X-rays on the subject or changes in the subject's posture.

The technology of the present disclosure has been made in view of the above facts, and an object thereof is to provide an X-ray fluoroscopic imaging apparatus that allows for visual confirmation of the positional relationship of a subject even when an X-ray shielding part is provided.

### Solution to Problem

To achieve the above object, an X-ray imaging apparatus according to a first aspect of the present disclosure includes: a tabletop having a placement surface on which a subject is placed; an irradiation unit that irradiates X-rays; a detection unit that detects X-rays that have been irradiated from the irradiation unit and have passed through the subject; an X-ray shielding part, one end of which is attached to the irradiation unit or the detection unit and the other end of which extends toward the placement surface; and a moving mechanism that moves the irradiation unit and the detection unit, wherein a space is formed in a part of the X-ray shielding part on the one end side, and a shielding transparent member that shields X-rays but transmits visible light is attached in the space.

### Effects of the Invention

According to the technology of the present disclosure, since a space is formed in a part of the X-ray shielding part on the one end side, and a shielding transparent member that shields X-rays but transmits visible light is attached in this space, the positional relationship of the subject can be visually confirmed through the shielding transparent member.

### BRIEF DESCRIPTION OF DRAWINGS

FIG. 1 is a front view for explaining an example of a schematic configuration of an X-ray imaging apparatus according to the present embodiment.

FIG. 2 is a right side view for explaining an example of a schematic configuration of the X-ray imaging apparatus according to the present embodiment.

FIG. 3 is a diagram showing an example of a state in which light of cross-lines is irradiated onto a subject placed on a placement stand of the X-ray imaging apparatus according to the present embodiment.

FIG. 4 is a diagram showing an example of a state in which the light of the cross-lines irradiated onto the subject is visually confirmed through a shielding transparent member.

### DESCRIPTION OF EMBODIMENTS

Hereinafter, embodiments of the technology of the present disclosure will be described with reference to the drawings.

### Configuration

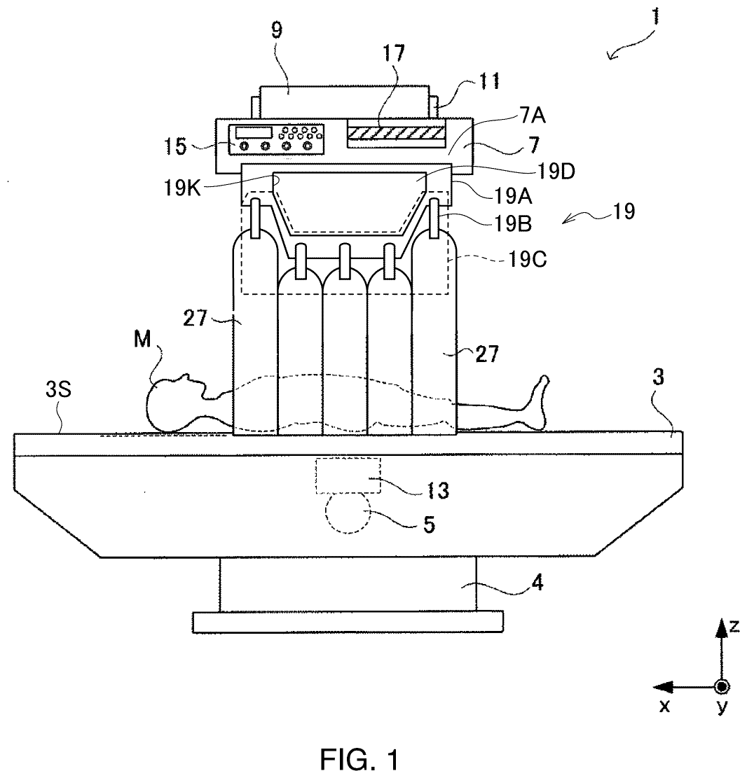

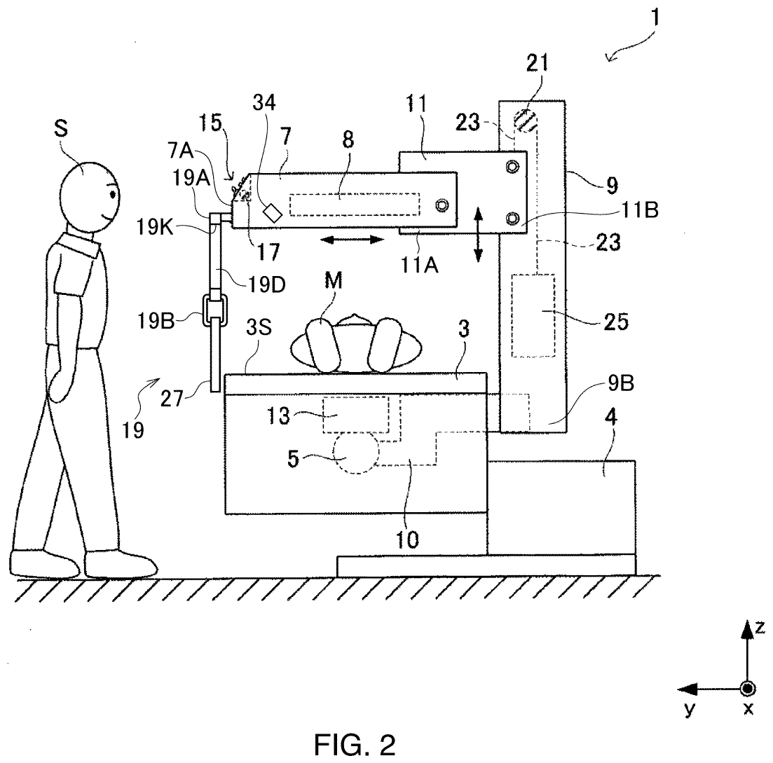

FIG. 1 is a front view for explaining an example of a schematic configuration of an X-ray imaging apparatus according to the present embodiment. FIG. 2 is a right side view for explaining an example of a schematic configuration of the X-ray imaging apparatus according to the present embodiment.

A longitudinal direction (left-right direction in FIG. 1) of a placement surface 3S, which will be described later, is defined as an X-direction. A short-side direction (left-right direction in FIG. 2) of the placement surface 3S, which is orthogonal to the longitudinal direction, is defined as a Y-direction. A direction perpendicular to both the X-direction and the Y-direction is defined as a Z-direction. The X-Y plane is a horizontal plane. The Z-direction is a height direction.

As shown in FIG. 1, an X-ray imaging apparatus 1 includes a tabletop 3 having a placement surface 3S on which a subject M is placed. The tabletop 3 is supported by a base 4 disposed on a floor surface. The placement surface 3S has a shape extending along a longitudinal direction and a short-side direction that intersects the longitudinal direction.

The X-ray imaging apparatus 1 includes an X-ray tube 5 disposed below the tabletop 3 for irradiating the subject M with X-rays. The X-ray imaging apparatus 1 includes a collimator 13 attached to the X-ray tube 5. The collimator 13 restricts the X-rays irradiated from the X-ray tube 5 into a predetermined shape. An example of the predetermined shape includes a cone shape forming a pyramid.

The X-ray imaging apparatus 1 includes an X-ray detection unit 7 disposed above the tabletop 3 so as to face the X-ray tube 5.

As shown in FIG. 2, the X-ray detection unit 7 includes an X-ray detector 8 that detects X-rays irradiated from the X-ray tube 5 and transmitted through the subject M, and outputs an X-ray detection signal. The X-ray detector 8 is arranged to face the X-ray tube 5 with the tabletop 3 interposed therebetween. Examples of the X-ray detector 8 include a flat panel detector or an image intensifier.

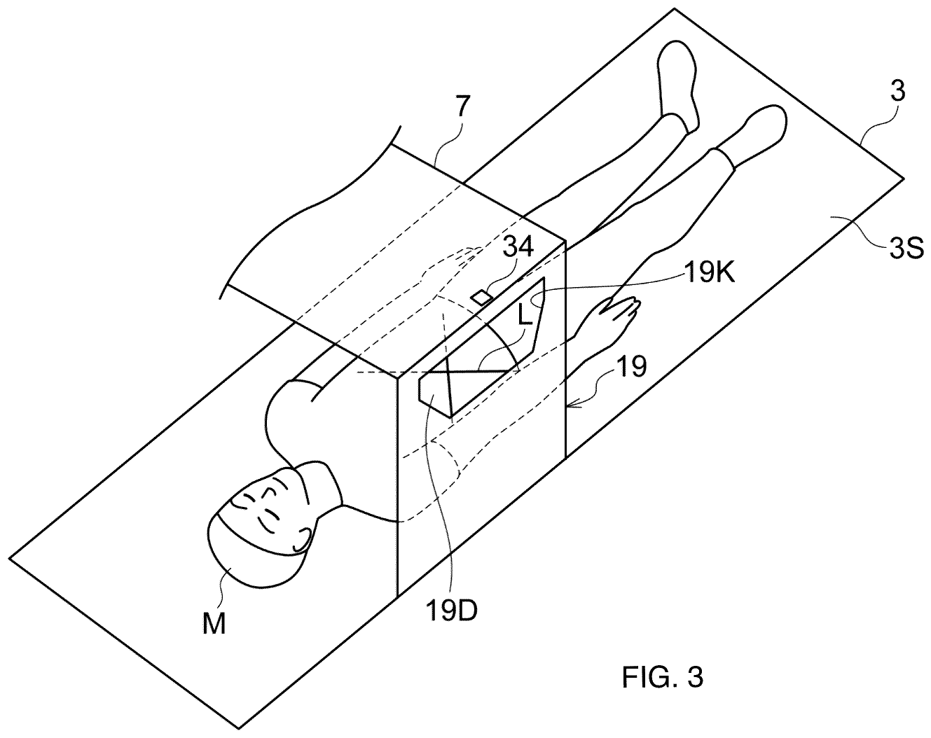

As shown in FIG. 2, the X-ray detection unit 7 includes a cross-line illumination device 34. FIG. 3 is a diagram showing an example of a state in which the cross-line illumination device 34 irradiates light of cross-lines L onto the subject M placed on the placement surface 3S of the X-ray imaging apparatus 1 according to the present embodiment. The cross-line illumination device 34 is an irradiation device that irradiates visible light onto the surface of the subject M. The cross-line illumination device 34 irradiates visible light such that an irradiated region on the surface of the subject M, onto which the visible light has been irradiated, has a shape in which a center coincides with an optical axis of the X-ray tube 5 and the X-ray detector 8, and a plurality of lines extend outward from the center. This shape is, for example, the cross-lines L as shown in FIG. 3. The shape is not limited to the cross-lines L and may be an asterisk or the like. Note that FIG. 3 schematically shows the state in which the cross-line illumination device 34 irradiates the light of the cross-lines L for easy understanding.

The X-ray tube 5 and the collimator 13 are an example of the “irradiation unit” of the technology of the present disclosure. The X-ray detector 8 is an example of the “detection unit” of the technology of the present disclosure. The cross-line illumination device 34 is an example of the “irradiation unit” of the technology of the present disclosure.

The arrangement is not limited to disposing the X-ray tube 5 and the collimator 13 below the tabletop 3 and the X-ray detector 8 above the tabletop 3. The X-ray detector 8 may be disposed below the tabletop 3, and the X-ray tube 5 and the collimator 13 may be disposed above the tabletop 3.

As shown in FIG. 2, the X-ray imaging apparatus 1 includes a support column 9. The support column 9 extends in a direction intersecting the tabletop 3 (specifically, the Z-direction).

A base end 9B of the support column 9 is connected to a connection part 10. The connection part 10 is also connected to the tabletop 3 and the X-ray tube 5. As described above, the collimator 13 is attached to the X-ray tube 5.

On an upper side of the support column 9, one end 11B of a branch part 11 extending in the short-side direction of the tabletop 3 is attached. The X-ray detection unit 7 is connected to the other end 11A of the branch part 11. As described above, the X-ray detection unit 7 includes the X-ray detector 8 and the cross-line illumination device 34.

The X-ray imaging apparatus 1 includes an X-direction moving mechanism that moves the support column 9, the X-ray detection unit 7 (the X-ray detector 8 and the cross-line illumination device 34), and the X-ray tube 5 and the collimator 13 in the X-direction along an unillustrated guide rail provided on the tabletop 3 and extending along the longitudinal direction of the placement surface 3S.

The X-ray imaging apparatus 1 includes a Y-direction moving mechanism that moves the support column 9, the X-ray detection unit 7 (the X-ray detector 8 and the cross-line illumination device 34), and the X-ray tube 5 and the collimator 13 in the Y-direction along an unillustrated guide rail provided on the tabletop 3 and extending along the short-side direction of the placement surface 3S.

As shown in FIG. 2, a pulley 21, a wire 23, and a counterweight 25 are built into the support column 9. The pulley 21 is built into an upper end part of the support column 9, and the wire 23 is passed over it. One end of the wire 23 is fixed to the branch part 11, and the other end of the wire 23 is fixed to the counterweight 25. The weight of the counterweight 25 is designed to balance the total weight of the branch part 11, the X-ray detection unit 7, and an X-ray shielding part 19.

The pulley 21 is rotatable in both forward and reverse directions, and the wire 23 can move in both directions in conjunction with the rotation of the pulley 21. Then, in conjunction with the movement of the wire 23, the branch part 11 connected to the wire 23 can move up and down along the support column 9. For example, when the pulley 21 is rotated in the forward direction shown in FIG. 2, the branch part 11 moves upward along the support column 9.

The pulley 21, the wire 23, and the counterweight 25 move the X-ray detection unit 7, specifically, the X-ray detector 8 and the cross-line illumination device 34, in the Z-direction via the branch part 11. The pulley 21, the wire 23, and the counterweight 25 constitute a Z-direction moving mechanism.

The X-direction moving mechanism, the Y-direction moving mechanism, and the Z-direction moving mechanism are an example of the “moving mechanism” of the technology of the present disclosure.

As shown in FIGS. 1 and 2, an operation handle 17 is provided at a distal end portion 7A of the X-ray detection unit 7. An operator can grip the operation handle 17 and move the X-ray detection unit 7 in the longitudinal direction of the tabletop 3, the short-side direction of the tabletop 3, and the direction perpendicular to the tabletop 3 by means of the X-direction moving mechanism, the Y-direction moving mechanism, and the Z-direction moving mechanism.

An operation panel 15 is provided at the distal end portion 7A of the X-ray detection unit 7. The operation panel 15 includes an operating device for setting X-ray irradiation conditions, an operating device for X-ray imaging, and the like, and the operator can input instructions related to X-ray fluoroscopic imaging by operating the operation panel 15. The configuration of the operation panel 15 includes, for example, a touch panel, a changeover switch, a push-button switch, or the like.

The operation panel 15 and the operation handle 17 may be installed at positions where the operator can easily operate them, and the arrangement position is not limited to the distal end portion of the X-ray detection unit 7.

At the distal end portion 7A of the X-ray detection unit 7, an X-ray shielding part 19 is disposed, one end of which is attached to the X-ray detection unit 7 and the other end of which extends toward the placement surface 3S. The X-ray shielding part 19 reduces the exposure dose of the operator due to X-rays irradiated from the X-ray tube 5. The X-ray shielding part 19 is arranged between an operator S, who performs various tasks in proximity to the X-ray imaging apparatus 1, and the tabletop 3.

The X-ray shielding part 19 includes a plurality of X-ray shielding plate-like members 27. The length in the X-direction and the length in the Z-direction of the plurality of X-ray shielding plate-like members 27 as a whole are geometrically predetermined based on an X-ray irradiated site of the subject M, a distance between the irradiated site and the operator (standard body type), and the length in the X-direction and the length in the Z-direction of the operator, so that scattered X-rays at the irradiated site do not impinge on the operator. The number of the X-ray shielding plate-like members 27 is, for example, five in the present embodiment, but it may be one as a whole, or it may be two, three, or the like.

The X-ray shielding part 19 includes a support part 19A, one end of which is attached to the X-ray detection unit 7. As described above, since the X-ray detection unit 7 includes the X-ray detector 8, the X-ray shielding part 19 is attached to the X-ray detector 8 via the X-ray detection unit 7. A space 19K is formed on one end side of a part of the X-ray shielding part 19, specifically, in the support part 19A. The space 19K is formed closer to the X-ray detector 8 side than a distal end of the X-ray shielding part 19 on the placement surface 3S side. That is, the region where the space 19K is formed does not include the area up to the distal end of the X-ray shielding part 19. A shielding transparent member 19D that shields X-rays but transmits visible light is attached in the space 19K. The length in the X-direction of the space 19K and the shielding transparent member 19D is equal to or greater than a standard distance between the eyes of the operator S, and the length in the Z-direction of the space 19K and the shielding transparent member 19D is equal to or greater than a standard length in the Z-direction of the eyes of the operator S. This standard distance between the eyes and the standard length of the eyes in the Z-direction are predetermined. The space 19K and the shielding transparent member 19D are provided on an upper side of the X-ray shielding part 19. Therefore, the operator S can check the X-ray irradiated site of the subject M by looking down from above.

The X-ray shielding part 19 includes an attachment fitting 19B that attaches one end of each of the plurality of X-ray shielding plate-like members 27 to the other end of the support part 19A such that the one end and the support part 19A are spaced apart, so that the other end of each of the plurality of X-ray shielding plate-like members 27 extends toward the placement surface 3S of the tabletop 3. The other end side of each of the plurality of X-ray shielding plate-like members 27 is freely movable. Therefore, even with the presence of the X-ray shielding part 19, it does not further hinder the placement of the subject M on the placement surface 3S. The support part 19A and the attachment fitting 19B are an example of the “attachment part” of the technology of the present disclosure.

The X-ray shielding part 19 includes an X-ray shielding body 19C that does not cover the space 19K of the support part 19A but covers a region where one end of each of the plurality of X-ray shielding plate-like members 27 and the support part 19A are spaced apart.

Each of the plurality of X-ray shielding plate-like members 27, the shielding transparent member 19D, and the X-ray shielding body 19C is formed of a substance that shields (specifically, absorbs) X-rays. This substance is specifically a substance in which an atomic nucleus has a sufficient number of protons to absorb the energy of X-rays and a corresponding number of electrons around it. Examples include lead (Pb), barium (Ba), and the like.

Each X-ray shielding plate-like member 27 and the X-ray shielding body 19C are formed of a substance that shields X-rays and visible light. Each X-ray shielding plate-like member 27 and the X-ray shielding body 19C are sheet-like shielding members made of lead or the like.

The shielding transparent member 19D is formed of a substance that shields X-rays but transmits visible light. For the shielding transparent member 19D, for example, a shielding transparent member made of lead-containing acrylic resin, lead-containing glass, barium-containing glass, or a polymer containing a heavy element such as barium or tungsten can be used. In the present embodiment, the shielding transparent member 19D is made of lead-containing acrylic resin.

The shielding transparent member 19D is more rigid than the X-ray shielding plate-like members 27.

### Operation

The operation of the X-ray imaging apparatus 1 will be described. First, the operator S places the subject M on the placement surface 3S of the tabletop 3 in a supine position.

The operator S operates a lighting button of the cross-line illumination device 34 on the operation panel 15 to irradiate visible light of the cross-lines L from the cross-line illumination device 34 onto the subject M. As described above, since the center of the cross-lines L coincides with the optical axis of the X-ray tube 5 and the X-ray detector 8, the operator S uses the operation handle 17 or the like to adjust the position of the imaging system such that the center of the cross-lines L is located on the surface of the subject M corresponding to the site to be subjected to X-ray fluoroscopic imaging.

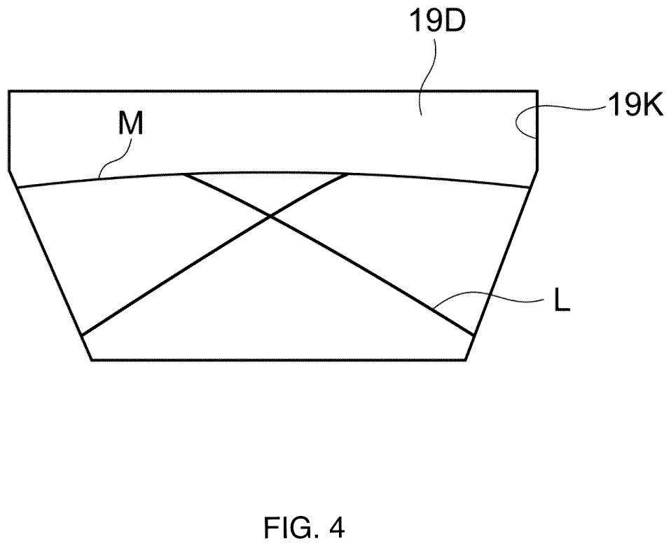

FIG. 4 is a diagram showing an example of a state in which the operator S visually confirms the light of the cross-lines L irradiated onto the subject M through the shielding transparent member 19D.

When adjusting the position of the imaging system, the operator S confirms the position of the cross-lines L and the subject M through the shielding transparent member 19D attached in the space 19K, and confirms the positional relationship of the subject, such as the irradiation position of X-rays on the subject M or changes in the posture of the subject M.

The operator S confirms the positional relationship of the subject M through the shielding transparent member 19D, and if the operator S determines that the center of the cross-lines L is not located on the surface corresponding to the site of the subject M to be subjected to X-ray fluoroscopic imaging, the operator S uses the operation handle 17 to adjust the position of the imaging system so that the center of the cross-lines L is located on the surface corresponding to the site of the subject M to be subjected to X-ray fluoroscopic imaging.

The operator S, who has determined that the center of the cross-lines L is located on the surface corresponding to the site of the subject M to be subjected to X-ray fluoroscopic imaging, operates an instruction button for X-ray fluoroscopic imaging on the operation panel 15. As a result, X-rays are irradiated from the X-ray tube 5 to the subject M via the collimator 13. The X-rays that have passed through the subject M are detected by the X-ray detector 8. The X-ray detector 8 outputs an X-ray detection signal. An X-ray image is generated based on the X-ray detection signal.

When the subject M is irradiated with X-rays, the X-rays are scattered. A part of the scattered X-rays travels toward the operator S. However, the X-rays traveling toward the operator S are shielded by the X-ray shielding part 19 and do not impinge on the operator S. Therefore, the operator S is not exposed to scattered X-rays due to the X-ray shielding part 19.

When the subject M is subjected to X-ray fluoroscopic imaging, the operator S can confirm the positional relationship of the subject through the shielding transparent member 19D. Therefore, an operator S who has confirmed that the subject M has moved during X-ray fluoroscopic imaging can perform X-ray fluoroscopic imaging again. Even in this case, since the shielding transparent member 19D shields X-rays, the operator S is not exposed.

### Effects

As described above, in the present embodiment, the shielding transparent member 19D, which shields X-rays but transmits visible light, is attached in the space 19K of the support part 19A of the X-ray shielding part 19. Therefore, the present embodiment provides the effect that, when the subject M is subjected to X-ray fluoroscopic imaging, the operator S can easily visually confirm the positional relationship of the subject through the shielding transparent member 19D, and at the same time, the operator S can be prevented from being exposed.

In the above embodiment, the attachment fitting 19B attaches one end of each of the plurality of X-ray shielding plate-like members 27 to the other end of the support part 19A such that the one end and the support part 19A are spaced apart, and the X-ray shielding body 19C does not cover the space 19K of the support part 19A but covers the spaced-apart region. Therefore, the present embodiment provides the effect that the operator S can be prevented from being exposed to scattered X-rays passing through the spaced-apart region.

In the above embodiment, the plurality of X-ray shielding plate-like members 27 are arranged such that the other end of each extends toward the placement surface 3S of the tabletop 3. Therefore, the present embodiment provides the effect that, if any one of the X-ray shielding plate-like members 27 is partially deteriorated or damaged, that X-ray shielding plate-like member 27 can be replaced individually, and it is not necessary to replace the entire X-ray shielding part 19, thus simplifying maintenance.

In the above embodiment, each of the plurality of X-ray shielding plate-like members 27, the shielding transparent member 19D, and the X-ray shielding body 19C shields X-rays by absorbing them, not by reflecting them. Therefore, the above embodiment provides the effect that it is possible to prevent reflected X-rays from scattering in an unpredictable direction other than the geometrically determined range, and to prevent the operator S from being exposed to the scattered X-rays.

In the above embodiment, the cross-line illumination device 34 irradiates visible light such that an irradiated region on the surface of the subject M, onto which the visible light has been irradiated, has a shape in which a center coincides with the optical axis of the X-ray tube 5 and the X-ray detector 8, and a plurality of lines extend outward from the center. Therefore, the above embodiment provides the effect that the position of the cross-lines L and the subject M can be easily confirmed, and the operator S can easily confirm whether the site of the subject M to be subjected to X-ray fluoroscopic imaging is correctly positioned at the location to be subjected to X-ray fluoroscopic imaging.

In the above embodiment, the operator can grip the operation handle 17 and move the X-ray detection unit 7 in the longitudinal direction of the tabletop 3, the short-side direction of the tabletop 3, and the direction perpendicular to the tabletop 3 by means of the X-direction moving mechanism, the Y-direction moving mechanism, and the Z-direction moving mechanism. Therefore, in the present embodiment, if the site of the subject M to be subjected to X-ray fluoroscopic imaging is not correctly positioned at the location to be subjected to X-ray fluoroscopic imaging, the position of the imaging system can be adjusted so that the site of the subject M to be subjected to X-ray fluoroscopic imaging is correctly positioned at the location to be subjected to X-ray fluoroscopic imaging. Therefore, the present embodiment provides the effect that the subject M can be correctly subjected to X-ray fluoroscopic imaging.

### Modification

In the above embodiment, the operator S operates the instruction button for X-ray fluoroscopic imaging on the operation panel 15. The technology of the present disclosure is not limited to this. For example, the X-ray shielding part 19 may be provided also in a case where the X-ray imaging apparatus 1 is remotely operated from a separate room different from the room where the X-ray imaging apparatus 1 is arranged, instead of using the operation panel 15. In this case, the moving mechanism may also be remotely operated.

### ASPECTS

It will be understood by those skilled in the art that the above embodiments are specific examples of the following aspects.

(Aspect 1) An X-ray imaging apparatus comprising: a tabletop having a placement surface on which a subject is placed; an irradiation unit that irradiates X-rays; a detection unit that detects X-rays that have been irradiated from the irradiation unit and have passed through the subject; an X-ray shielding part, one end of which is attached to the irradiation unit or the detection unit and the other end of which extends toward the placement surface; and a moving mechanism that moves the irradiation unit and the detection unit, wherein a space is formed in a part of the X-ray shielding part on the one end side, and a shielding transparent member that shields X-rays but transmits visible light is attached in the space.

According to the X-ray imaging apparatus of Aspect 1, it is possible to provide the effect that, when a subject is subjected to X-ray fluoroscopic imaging, an operator can easily visually confirm the positional relationship of the subject through the shielding transparent member, and at the same time, the operator can be prevented from being exposed.

(Aspect 2) The X-ray imaging apparatus according to claim 1, wherein the shielding transparent member is more rigid than the X-ray shielding part.

(Aspect 3) The X-ray imaging apparatus according to claim 1 or 2, further comprising an attachment part that attaches the one end of the X-ray shielding part to the irradiation unit or the detection unit, wherein the attachment part includes a support part and an attachment fitting that attaches the one end of the X-ray shielding part to the support part such that the one end and the support part are spaced apart, and the X-ray shielding part further includes an X-ray shielding body that does not cover the space but covers the spaced-apart region.

According to the X-ray imaging apparatus of Aspect 3, it is possible to provide the effect that an operator can be prevented from being exposed to scattered X-rays passing through the spaced-apart region.

(Aspect 4) The X-ray imaging apparatus according to any one of claims 1 to 3, further comprising an attachment part that attaches the one end of the X-ray shielding part to the irradiation unit or the detection unit, wherein the X-ray shielding part includes a plurality of X-ray shielding plate-like members, and the attachment part attaches one end of each of the plurality of X-ray shielding plate-like members to the irradiation unit or the detection unit such that the other end of each of the plurality of X-ray shielding plate-like members extends toward the placement surface of the tabletop.

According to the X-ray imaging apparatus of Aspect 4, it is possible to provide the effect that, if any one of the X-ray shielding plate-like members is partially deteriorated or damaged, that X-ray shielding plate-like member can be replaced individually, and it is not necessary to replace the entire X-ray shielding part, thus simplifying maintenance.

(Aspect 5) The X-ray imaging apparatus according to any one of claims 1 to 4, wherein the shielding transparent member and the shielding part are composed of a material that absorbs the X-rays.

According to the X-ray imaging apparatus of Aspect 5, it is possible to provide the effect that it is possible to prevent reflected X-rays from scattering in an unpredictable direction other than the geometrically determined range, and to prevent the operator S from being exposed to the scattered X-rays.

(Aspect 6) The X-ray imaging apparatus according to any one of claims 1 to 5, further comprising an irradiation unit that irradiates visible light onto a surface of the subject, wherein the irradiation unit irradiates the visible light such that an irradiated region on the surface of the subject, onto which the visible light has been irradiated, has a shape in which a center coincides with an optical axis of the irradiation unit and the detection unit, and a plurality of lines extend outward from the center.

According to the X-ray imaging apparatus of Aspect 6, it is possible to provide the effect that an operator can easily confirm whether the site of the subject to be subjected to X-ray fluoroscopic imaging is correctly positioned at the location to be subjected to X-ray fluoroscopic imaging.

(Aspect 7) The X-ray imaging apparatus according to any one of claims 1 to 6, wherein the placement surface has a shape extending along a longitudinal direction and a short-side direction that intersects the longitudinal direction, and the moving mechanism is configured to be able to move the irradiation unit and the detection unit along at least one of the longitudinal direction, the short-side direction, and a direction intersecting each of the longitudinal direction and the short-side direction.

According to the X-ray imaging apparatus of Aspect 7, it is possible to provide the effect that a subject can be correctly subjected to X-ray fluoroscopic imaging.

(Aspect 8) The X-ray imaging apparatus according to any one of claims 1 to 7, wherein one of the irradiation unit and the detection unit is located in a first region on a side where the subject is placed with respect to the placement surface, the other of the irradiation unit and the detection unit is located in a second region opposite to the first region with respect to the placement surface, and one end of the X-ray shielding part is attached to the one of the irradiation unit or the detection unit.

### REFERENCE SIGNS LIST

1 X-ray imaging apparatus
3 tabletop
3S placement surface
5 X-ray tube
13 collimator
8 X-ray detector
34 cross-line illumination device
21 pulley
23 wire
25 counterweight
19 X-ray shielding part
19A support part
19K space
19D shielding transparent member
19B attachment fitting
19C X-ray shielding body
27 X-ray shielding plate-like member

1. An X-ray imaging apparatus, comprising:
a tabletop having a placement surface on which a subject is placed;
an irradiation unit that irradiates X-rays;
a detection unit that detects X-rays that have been irradiated from the irradiation unit and have passed through the subject;
an X-ray shielding part, one end of which is attached to the irradiation unit or the detection unit and the other end of which extends toward the placement surface; and
a moving mechanism that moves the irradiation unit and the detection unit,
wherein a space is formed in a part of the X-ray shielding part on the one end side, and
a shielding transparent member that shields X-rays but transmits visible light is attached in the space.

2. The X-ray imaging apparatus according to claim 1, wherein the shielding transparent member is more rigid than the X-ray shielding part.

3. The X-ray imaging apparatus according to claim 1, further comprising an attachment part that attaches the one end of the X-ray shielding part to the irradiation unit or the detection unit,
wherein the attachment part includes a support part and an attachment fitting that attaches the one end of the X-ray shielding part to the support part such that the one end and the support part are spaced apart, and
the X-ray shielding part further includes an X-ray shielding body that does not cover the space but covers the spaced-apart region.

4. The X-ray imaging apparatus according to claim 1, further comprising an attachment part that attaches the one end of the X-ray shielding part to the irradiation unit or the detection unit,
wherein the X-ray shielding part includes a plurality of X-ray shielding plate-like members, and
the attachment part attaches one end of each of the plurality of X-ray shielding plate-like members to the irradiation unit or the detection unit such that the other end of each of the plurality of X-ray shielding plate-like members extends toward the placement surface of the tabletop.

5. The X-ray imaging apparatus according to claim 1, wherein the shielding transparent member is composed of a material that absorbs the X-rays.

6. The X-ray imaging apparatus according to claim 1, further comprising an irradiation unit that irradiates visible light onto a surface of the subject,
wherein the irradiation unit irradiates the visible light such that an irradiated region on the surface of the subject, onto which the visible light has been irradiated, has a shape in which a center coincides with an optical axis of the irradiation unit and the detection unit, and a plurality of lines extend outward from the center.

7. The X-ray imaging apparatus according to claim 1, wherein the placement surface has a shape extending along a longitudinal direction and a short-side direction that intersects the longitudinal direction, and
the moving mechanism is configured to be able to move the irradiation unit and the detection unit along at least one of the longitudinal direction, the short-side direction, and a direction intersecting each of the longitudinal direction and the short-side direction.

8. The X-ray imaging apparatus according to claim 1,
wherein one of the irradiation unit and the detection unit is located in a first region on a side where the subject is placed with respect to the placement surface,
the other of the irradiation unit and the detection unit is located in a second region opposite to the first region with respect to the placement surface, and
one end of the X-ray shielding part is attached to the one of the irradiation unit or the detection unit.
